(19) United States
(12) Patent Application Publication
(10) Pub. No.: US 2025/0171271 A1
(43) Pub. Date: May 29, 2025

(54) METHOD FOR CONTROLLING AN ELEVATOR

(71) Applicant: Inventio AG, Hergiswil (CH)

(72) Inventors: Nicola Ischia, Milano (IT); Vincent Cabrini, Thalwil (CH); Thomas Cros, Toulouse (FR)

(21) Appl. No.: 18/993,626

(22) PCT Filed: Jul. 13, 2023
(86) PCT No.: PCT/EP2023/069415

§ 371 Date: Jan. 13, 2025

(30) Foreign Application Priority Data
Jul. 19, 2022 (EP) 22185609.9

(51) Int. Cl. B66B 1/06; B66B 1/34

(52) U.S. Cl. CPC B66B 1/06; B66B 1/3492; B66B 2201/231; B66B 2201/30; B66B 2201/403

(57) ABSTRACT

An elevator has a plurality of cars movable along different vertical axes between building floors and a sensor system providing sensor data indicative of the elevator current state. An elevator control method includes: receiving the sensor data including current position of each car relative to the floors, list of assigned current calls and a new call for assignment each indicating a destination floor; generating a list of eligible cars using the sensor data and at least one rule with which each car should comply when fulfilling the new call; inputting the sensor data as input data into an artificial neural network trained to convert the input data into one output value for each car indicating a probability and/or tendency for assignment of the car to the new call; determining one of the eligible cars as a selected car using the output values; assigning the new call to the selected car.

### FIELD

The invention relates to a method for controlling an elevator. The invention further relates to an elevator, as well as to an elevator controller, a computer program and a computer-readable medium for carrying out the method.

### BACKGROUND

An elevator may comprise different cars for transporting people and/or objects along different vertical axes or shafts between different floors of a building. Given a list of calls indicating desired floors of the building, the controller of the elevator needs to be able to assign each call to one of the cars and determine the order of the floors at which the cars should stop to fulfil the assigned calls in an efficient manner. This may also be referred to as trip scheduling.

Especially in very tall buildings with multiple floors and multiple elevators operating at the same time, solving the trip scheduling problem using conventional elevator control algorithms, which are usually based on a set of known rules, may become very complex. In such scenarios, a machine-learning model may be utilized to make better control decisions. Such models are usually trained using reinforcement learning, where actions of a simulated elevator (“agent”) are evaluated with rewards and an algorithm that controls the agent (e.g. in the form of an artificial neural network) is optimized according to the rewards so that future control decisions are better than past control decisions.

U.S. Pat. No. 5,767,461 A describes a method for controlling an elevator with cars in separate elevator shafts using an artificial neural network. EP 2 149 532 A1 and EP 1 733 990 A1 describe such a method using dedicated rules for choosing one of several elevator cars when a new call arrives.

### SUMMARY

It may be seen as an objective of the invention to provide an improved method for controlling an elevator that comprises two or more cars. Another objective of the invention may be to provide a corresponding elevator, a corresponding elevator controller, a corresponding computer program and a corresponding computer-readable medium.

These objectives may be achieved by the subject matter of the advantageous embodiments defined in the following description and the attached drawings.

A first aspect of the invention relates to a computer-implemented method for controlling an elevator, wherein the elevator comprises different cars arranged to be movable along different vertical axes between different floors of a building and a sensor system adapted to provide sensor data indicative of a current state of the elevator. The method comprises: receiving the sensor data, wherein the sensor data includes a current position of each car with respect to the floors, a list of current calls assigned to the cars and a new call to be assigned to one of the cars, wherein each call indicates a desired floor of the building; generating a list of eligible cars from a list of the cars using the sensor data and at least one rule with which each car should comply when fulfilling the new call; inputting the sensor data as input data into an artificial neural network trained to convert the input data into one output value for each car, wherein the output value indicates a probability and/or tendency for the car to be assigned to the new call; determining an item from the list of eligible cars as a selected car using the output values; assigning the new call to the selected car.

In other words, the list of eligible cars may be used as a filter for filtering the output of the artificial neural network. Such filtering may also be referred to as masking. This significantly improves the accuracy of the method compared to elevator group control algorithms that lack such masking.

The method may be carried out automatically by a processor.

The current position of a car may be an ID of a floor on or near which the car is currently located.

A desired floor may be a destination floor and/or an origin floor. For example, each call may be defined by a unique ID, a timestamp, an origin floor and a destination floor.

Generating the list of eligible cars may comprise, for example, estimating a future state of each car from the input data and evaluating the future state and/or a transition from a current state of the car to the future state using the at least one rule.

The rule(s) may be based on predefined and/or known parameters (as opposed, for example, to a machine-learning model with hidden parameters).

It is possible that at least two different rules are used to generate the list of eligible cars. In this case, a car may be added to the list of eligible cars only if it complies with each one of the rules when fulfilling the new call.

The artificial neural network may be, for example, a multilayer perceptron (MLP), a convolutional neural network (CNN), a recurrent neural network (RNN), a long short-term memory (LSTM), a graph neural network (GNN) or a combination of at least two of these examples. In particular, the artificial neural network may have been trained using a policy-based and/or value-based reinforcement learning algorithm.

The input data may encode the sensor data in a format specifically adapted to the artificial neural network, e.g. in the form of a vector. It is also possible that the input data is identical to the sensor data. In this case, the sensor system may be adapted to provide the sensor data as the input data in a format specifically adapted to the artificial neural network.

The input data may be input into one, two or more than two artificial neural networks, e.g. into one artificial neural network for each car, to generate the output value(s).

The input data may further include additional data indicative of the current state of the elevator. For example, the additional data may include the current moving direction (e.g. “up”, “down”, “stopped”) and/or the current occupancy (e.g. “full”, “not full”) of each car. This may improve the accuracy of the method.

For example, the input data may be an observation vector with different components, such as the number of the floor on or near which each car is currently located (e.g. “0”, “1”, “2”), the current moving direction of each car (e.g. “up”, “down”, “stopped”), the occupancy of each car (e.g. “full”, “not full”), the current calls assigned to each car, the new call to be assigned to one of the cars.

A simple approach to encode the calls for one car may be to combine the following three components.

1) All landing operating panel (LOP) calls assigned to the car may be provided as origin-destination tuples and aggregated into one (two-dimensional) origin-destination matrix. The matrix may then be transformed into a first vector of length n², with n being the number of floors of the building. The named LOP calls include especially the information about the origin floor and additionally about the destination floor. Such LOP calls are often named as destination calls.

2) All new LOP calls, which are to be assigned to the car, may be transformed into a second vector of length n² in the same way as described under 1).

3) All car operating panel (COP) calls from the car may be directly stored in a third vector of length n, since there is no need to remember the origin for COP calls.

The first vector, the second vector and the third vector of all cars may then be concatenated to form the observation vector.

The output values may be values from a discrete and/or continuous value range. For example, the output values may be Q values and/or bid values. The output values may also be percentages between 0 and 1 or Boolean values.

A second aspect of the invention relates to an elevator controller comprising a processor configured to carry out the method described above and below. An elevator controller is a special data processing device, designed and programmed to control an elevator. The elevator controller may comprise an elevator group controller and a car controller. The elevator controller may include hardware and/or software modules. In addition to the processor, the elevator controller may comprise a memory and one or more data communication interfaces for data communication with peripheral devices, e. g sensors, sensor systems or actuators of an elevator.

A third aspect of the invention relates to an elevator. The elevator comprises: at least two different cars arranged to be movable along different vertical axes between different floors of a building; a sensor system adapted to provide sensor data indicative of a current state of the elevator, wherein the sensor data includes a current position of each car with respect to the floors, a list of current calls assigned to the cars and a new call to be assigned to one of the cars, wherein each call indicates a desired floor of the building; the elevator controller described above and below.

For example, the cars may be arranged to be movable along different shafts of the building. In particular, each car may be arranged to be movable in its own shaft.

Further aspects of the invention relate to a computer program comprising instructions which, when the program is executed by a processor, cause the processor to carry out the method described above and below, as well as to a computer-readable medium in which the computer program is stored.

The computer-readable medium may be a volatile or non-volatile data storage device. For example, the computer-readable medium may be a hard drive, a USB (universal serial bus) storage device, a RAM (random-access memory), a ROM (read-only memory), an EPROM (erasable programmable read-only memory), an EEPROM (electrically erasable programmable read-only memory), a flash memory or a combination of at least two of these examples. The computer-readable medium may also be a data communication network for downloading program code, such as the Internet or a cloud.

It should be noted that features of the method described above and below may also be features of the elevator controller, the computer program and the computer-readable medium (and vice versa).

Embodiments of the invention may be regarded as based on the ideas and findings described below without limiting the invention.

According to an embodiment, the following steps may be performed for each car to generate the list of eligible cars: assigning the new call to the car; simulating a movement of the car to fulfil the new call depending on the current position of the car and the current calls assigned to the car; analyzing the movement to determine whether the car complies with the at least one rule; if the car complies with the at least one rule, adding the car to the list of eligible cars. Such an algorithm can be easily implemented.

According to an embodiment, the movement may be simulated according to a (known) control logic for controlling the car independently of any other car of the elevator. Such a single-car control logic may be, for example, a selective collective logic or a down collective logic. The control logic may be based on known rules and/or known parameters. However, it is also possible for the control logic to include a machine-learning model with hidden, i.e. unknown parameters, such as an artificial neural network. It is possible that the same control logic is used to both simulate the movement of a car and generate control commands for actually controlling the car.

According to an embodiment, the at least one rule may specify a preferred moving direction for each car. In other words, a car may be added to the list of eligible cars only if it moves in the preferred moving direction when fulfilling the new call.

According to an embodiment, the at least one rule may specify a maximum number of calls that can be assigned to each car. In other words, a car may be added to the list of eligible cars only if the number of calls assigned to the car when it fulfils the new call does not exceed its maximum number of calls.

According to an embodiment, the selected car may be the eligible car corresponding to the highest output value, e.g. the highest Q value. Alternatively, the selected car may be the eligible car corresponding to the lowest output value, e.g. the lowest bid value.

According to an embodiment, the artificial neural network may have been trained using training data generated by simulating an environment in which different cars of an elevator move along different vertical axes between different floors of a building in reaction to calls indicating desired floors of the building.

The environment may be seen as a computer-calculated space the elevator, as a virtual agent, takes actions in. The environment may have the same and/or similar characteristics as the real elevator and/or the real building in which the real elevator is installed.

As an example, the simulation of the environment may comprise the following components: elevator simulation, traffic simulation, interaction between elevator simulation and traffic simulation. The elevator simulation may be configured with at least one of the following parameters: maximum velocity, acceleration, door opening time, door closing time, minimum door open time, car capacity. The traffic simulation may be performed according to a specific traffic pattern that determines a local and/or temporal distribution of calls to be fulfilled by the elevator. For example, as mentioned above, each call may be characterized by a unique ID, a timestamp, an origin floor and a destination floor. The traffic pattern may be varied during simulation. The simulation of the interaction between the elevator and the calls (i.e. the passengers) may be configured with parameters such as a waiting time (i.e. the time a passenger waits before entering the car), a travelling time (i.e. the time a passenger travels before leaving the car) or a destination time (i.e. the overall time it takes to fulfil a call).

In general, the agent, e.g. an elevator group controller, may be configured to receive an observation of the environment in each simulation step and execute an action depending on the observation, e.g. assign a new call to one of the cars and, optionally, control the car accordingly. As a reaction, the environment may update its state and emit an observation of its updated state together with a reward that is used to train the agent to improve its actions at future simulation steps.

The reward may be positive, negative or zero. For example, a positive reward value may indicate a “more useful” action, whereas a negative reward value may indicate a “less useful” action. The reward may be calculated in regular time intervals or only in certain situations, e.g. when a transition of the environment from a current state to a next state is observed.

The state of the environment may be seen as a combination of both an elevator state and a traffic state. The elevator state may be defined, for example, by at least one of the following parameters: a current floor of each car, a current moving direction of each car, a current door status (opened, moving, closed) of each car, a current number of passengers inside each car, the next reachable floors of each car. The traffic state may be defined, for example, by at least one of the following parameters: active calls from and/or to each floor, a current number of passengers inside each car, a current number of passengers waiting on each floor.

The actions may be selected with a certain degree of randomness during training, e.g. by using an epsilon-greedy algorithm. The degree of randomness may be varied, in particular reduced, as the training progresses.

According to an embodiment, the method may further comprise generating a control command to cause the selected car to fulfil the new call. The control command may be generated to control a movement of the selected car along one of the vertical axes, e.g. along a shaft of the building. The control command may be generated considering the other calls assigned to the selected car. Examples for such a control command are “go up”, “go down”, “go to floor X” or “go to the next floor”. The control command may also cause the selected car to close and/or open its door(s) and/or to fulfil the other calls assigned to it.

According to an embodiment, generating the control command may comprise: receiving additional input data including the current position of the selected car and a list of all calls assigned to the selected car, including the new call; inputting the additional input data into an additional artificial neural network trained to convert the additional input data into at least one additional output value indicating a possible control command from a set of possible control commands for controlling the selected car; selecting one of the possible control commands as the control command using the at least one additional output value; applying the control command to cause the selected car to fulfil the new call. In other words, different artificial neural networks may be used to assign the new call to one of the cars and control the selected car to which the new call has been assigned. This significantly improves the accuracy and/or efficiency of the method.

For example, the additional artificial neural network may be configured to calculate one output value, e.g. one Q value, for each possible control command. In this case, the control command may be the possible control command corresponding to the highest output value, e.g. the highest Q value.

According to an embodiment, the additional artificial neural network may have been trained using training data generated by simulating an environment in which at least one car of an elevator moves between different floors of a building in reaction to calls indicating desired floors of the building. The environment may have the same and/or similar characteristics as the real elevator and/or the real building in which the real elevator is installed. In particular, the environment may include only one car. The additional artificial neural network may have been trained in a similar manner as described above. In this case, however, the agent, e.g. an elevator car controller, may be configured to execute actions in the environment by applying control commands for controlling a single car of the elevator (instead of assigning new calls to different cars of the elevator).

According to an embodiment, the processor of the elevator controller may be configured to carry out the method of the first aspect of the invention according to an embodiment where a control command is generated. In this case, the elevator may further comprise an actuator system adapted to control the cars according to control commands generated by the elevator controller.

Advantageous embodiments of the invention are described in more detail below with reference to the attached drawings. Neither the description nor the drawings are to be construed as limiting the invention.

### DESCRIPTION OF THE DRAWINGS

FIG. 1 shows an elevator according to an embodiment of the invention.

FIG. 2 shows an elevator group controller of an elevator controller according to an embodiment of the invention.

FIG. 3 shows a car controller of an elevator controller according to an embodiment of the invention.

The figures are merely schematic and not to scale. Identical reference signs in the drawings denote identical features or features having the same effect.

### DETAILED DESCRIPTION

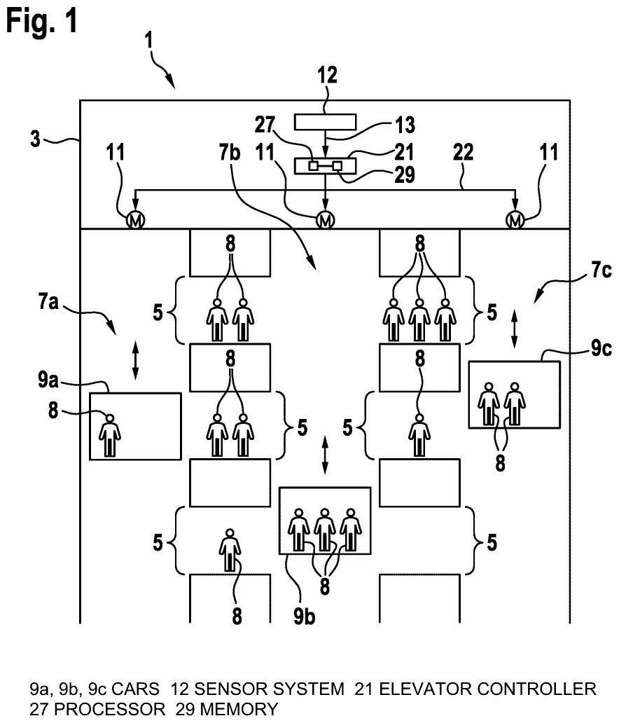

FIG. 1 shows an elevator 1 installed in a building 3 with multiple floors 5 and multiple shafts that interconnect the floors 5, here a first shaft 7a, a second shaft 7b and a third shaft 7c. The elevator 1 comprises multiple cars to transport passengers 8 between the floors 5, here a first car 9a arranged to be movable along the first shaft 7a, a second car 9b arranged to be movable along the second shaft 7b and a third car 9c arranged to be movable along the third shaft 7c.

The elevator 1 further comprises an actuator system 11 adapted to control a movement of each car 9a, 9b, 9c. In this example, the actuator system 11 includes one electric drive (“M”) for each car 9a, 9b, 9c.

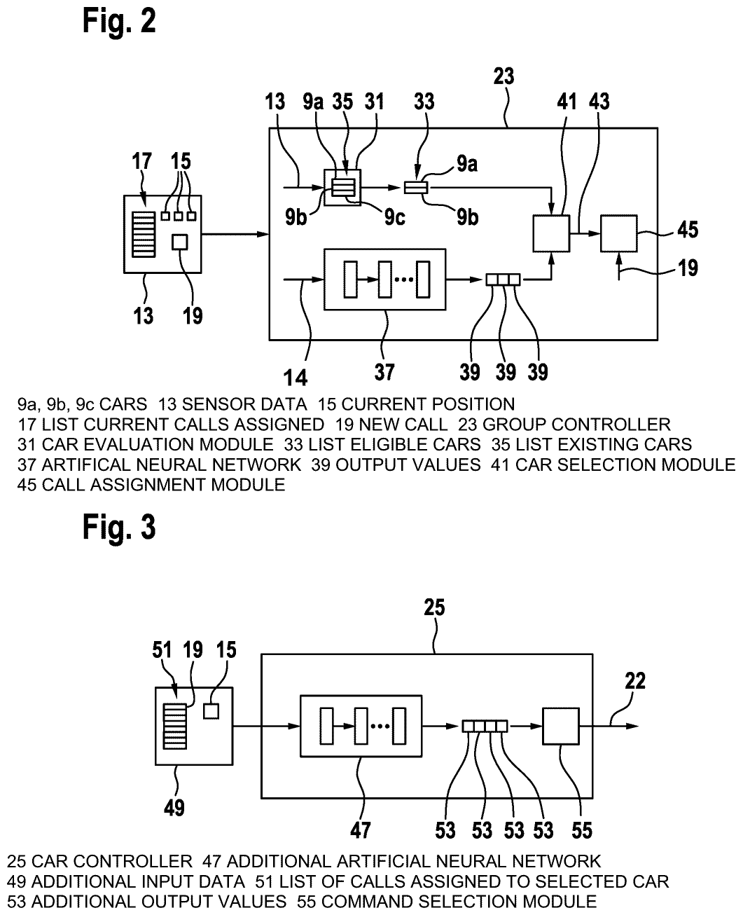

In addition, the elevator 1 comprises a sensor system 12 adapted to provide sensor data 13 including a current position 15 (see FIGS. 2, 3) of each car 9a, 9b, 9c with respect to the floors 5, a list 17 (see FIG. 2) of current calls assigned to the cars 9a, 9b, 9c and a new call 19 (see FIGS. 2, 3) to be assigned to one of the cars 9a, 9b, 9c.

As shown in FIG. 1, an elevator controller 21 of the elevator 1 may be configured to generate a control command 22 for controlling the actuator system 11 from the sensor data 13.

In this example, the elevator controller 21 includes a group controller 23 (see FIG. 2) configured to assign the new call 19 to one of the cars 9a, 9b, 9c, as well as three car controllers 25 (see FIG. 3), wherein each car controller 25 is configured to generate a control command 22 for one of the cars 9a, 9b, 9c, i.e. the corresponding electric drive. It is possible for the car controllers 25 to generate their control commands 22 independently of each other.

The elevator controller 21 comprises a processor 27 and a memory 29. The processor 27 may be configured to carry out the following method by executing a computer program stored in the memory 29.

At a first step, the sensor data 13 is received at the elevator controller 21, here at a car evaluation module 31 of the group controller 23.

At a second step, the car evaluation module 31 generates a list 33 of eligible cars from a list 35 of all existing cars 9a, 9b, 9c using the sensor data 13 and at least one rule with which each car 9a, 9b, 9c should comply when fulfilling the new call 19. In this example, the list 33 includes the cars 9a, 9b as the eligible cars.

In parallel, at a third step, input data 14 encoding the sensor data 13 is input into an artificial neural network 37 that has been trained, e.g. by a policy-based and/or value-based reinforcement learning algorithm, to convert the input data 14 into a set of output values 39, here three output values 39, wherein each output value 39 indicates a probability and/or tendency for one of the three cars 9a, 9b, 9c.

At a fourth step, the list 33 of eligible cars and the output values 39 are input into a car selection module 41 that determines a selected car 43 from the eligible cars depending on the output value 39 assigned to each item in the list 33. In this example, the car 9a is the car with the highest output value 39 and is thus determined as the selected car 43.

At a fifth step, the new call 19 is assigned to the selected car 43 in a call assignment module 45.

At a sixth step, the car controller 25 (FIG. 3) of the selected car 43 additionally generates a control command 22 that causes the actuator system 11, i.e. the electric drive of the selected car 43, to move the selected car 43 in such a way that it fulfils the new call 19.

In general, if there are n cars, the final layer of the neural network 37 may generate n output values 39, e.g. Q values. The car selection module 41 may then determine the car with the highest Q-value as the selected car 43.

As mentioned above, the selected car 43 may follow a single-car logic, such as a selective collective logic or a down collective logic, to satisfy the calls assigned to it. The single-car logic may be based on a set of known rules and/or implemented as an artificial neural network (see below).

For example, the list 33 of eligible cars may be generated by executing the following algorithm for each car (“c”).

i) Assign the new call 19 to c.

ii) Simulate a movement of c following the single-car logic.

iii) Check if at point (ii) one or more rules are broken.

iv) If no rules are broken, add c to the list 33 of eligible cars.

The list 33 may then be used to mask the output of the neural network 37, i.e. to filter the output values 39 (“Q”):

selected_car={c such that Q_{c}=max({Qᵢ}) and c∈eligible_cars}

If the list 33 is empty, the new call 19 may be delayed for a certain period of time.

As an example, the following two rules may be used to evaluate the simulated movement.

1. Wrong direction: A new call cannot be assigned to a car if the car moves in a direction opposite to a preferred moving direction to fulfil the new call.

2. Full car: A new call cannot be assigned to a car if the car, when fulfilling the new call, exceeds a maximum number of calls that can be assigned to it. In other words, a new passenger is unable to enter the car at the origin floor specified by the new call if the car is full.

Optionally, the car controller 25 may be configured to estimate the control command 22 for the selected car 43 using an additional artificial neural network 47, which may have been trained in a similar manner as the neural network 37, i.e. using a reinforcement learning algorithm, to convert additional input data 49, which includes the current position 15 of the selected car 43 and a list 51 of all calls currently assigned to the selected car 43, including the new call 19, into a set of additional output values 53, wherein each additional output value 53 indicates a control command from a set of possible control commands for controlling the selected car 43. The additional input data 49 may have been generated using the sensor data 13 and/or the input data 14.

The additional output values 53 may then be input into a command selection module 55 that selects the possible control command corresponding to the highest additional output value 53 as the control command 22 and applies the control command 22 to the actuator system 11.

As pointed out above, the additional neural network 47 may also be used to simulate the movement of one of the cars 9a, 9b, 9c, e.g. to estimate control commands for one of the cars 9a, 9b, 9c, to determine whether the car is eligible.

The two neural networks 37, 47 may have been trained using training data generated by simulating a behavior of the elevator 1 in a virtual building in reaction to virtual calls.

The modules described above may be software and/or hardware modules.

Finally, it is noted that terms such as “comprising”, “including”, “having” or “with” do not exclude other elements or steps and that the indefinite article “a” or “an” does not exclude a plurality. It is further noted that features or steps described with reference to one of the above embodiments may also be used in combination with features or steps described with reference to any other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A computer-implemented method for controlling an elevator, the elevator including a plurality of cars movable along different vertical axes between different floors of a building and a sensor system providing sensor data indicative of a current state of the elevator, the method comprising steps of:
receiving the sensor data, wherein the sensor data includes a current position of each of the cars with respect to the floors, a list of current calls assigned to the cars and a new call to be assigned to one of the cars, wherein each of the assigned calls and the new call indicates a destination floor of the floors;
generating a list of eligible cars from a list of the cars using the sensor data and at least one rule with which each of the cars should comply when fulfilling the new call;
inputting the sensor data as input data into an artificial neural network trained to convert the input data into an output value for each of the cars, wherein the output value for each of the cars indicates a probability and/or tendency for the new call to be assigned to the car;
determining from the list of eligible cars one of the eligible cars as a selected car using the output values; and
assigning the new call to the selected car.

17. The method according to claim 16 including generating the list of eligible care by performing for each one of the cars steps of:
assigning the new call to the one car;
simulating a movement of the one car to fulfil the new call depending on the current position of the one car and the current calls assigned to the one car;
analyzing the simulated movement and determining whether the one car complies with the at least one rule; and
when the one car complies with the at least one rule, adding the one car to the list of eligible cars.

18. The method according to claim 17 wherein the movement is simulated according to a control logic for controlling the one car independently of any other of the cars.

19. The method according to claim 16 wherein the at least one rule specifies a preferred moving direction for each of the cars.

20. The method according to claim 16 wherein the at least one rule specifies a maximum number of calls that can be assigned to each of the cars.

21. The method according to claim 16 wherein the selected car is a one of the eligible cars corresponding to a highest one of the output values, or wherein the selected car is a one of the eligible cars corresponding to a lowest one of the output values.

22. The method according to claim 16 wherein the artificial neural network was trained using training data generated by simulating an environment in which different ones of the cars move along different ones of the vertical axes between different ones of the floors in reaction to calls each indicating a destination floor of the floors.

23. The method according to claim 16 including generating a control command causing the selected car to fulfil the new call.

24. The method according to claim 23 including generating the control command by performing steps of:
receiving additional input data including the current position of the selected car and a list of all calls assigned to the selected car including the new call;
inputting the additional input data into an additional artificial neural network trained to convert the additional input data into at least one additional output value indicating a possible control command from a set of possible control commands for controlling the selected car;
selecting one of the possible control commands as the control command using the at least one additional output value; and
applying the control command to cause the selected car to fulfil the new call.

25. The method according to claim 24 wherein the additional artificial neural network was trained using training data generated by simulating an environment in which at least one of the cars moves between different ones of the floors in reaction to calls each indicating a destination floor of the floors.

26. An elevator controller comprising a processor adapted to carry out the method according to claim 16.

27. An elevator comprising:
a plurality of cars movable along different vertical axes between different floors of a building;
a sensor system providing sensor data indicative of a current state of the elevator, wherein the sensor data includes a current position of each of the cars with respect to the floors, a list of current calls assigned to the cars and a new call to be assigned to one of the cars, wherein each of the assigned current calls and the next call indicates a destination floor of the floors; and
the elevator controller according to claim 26 connected to the cars and the sensor system.

28. The elevator according to claim 27 including an actuator system adapted to control the cars according to a control command generated by the elevator controller.

29. A computer program comprising instructions stored on a non-transitory computer-readable medium wherein the instruction when executed by a processor of an elevator controller cause the elevator controller to perform the method according to claim 16.

30. A non-transitory computer-readable medium comprising instructions stored thereon wherein the instructions when executed by a processor of an elevator controller cause the processor to perform the method according to claim 16.
